(19) United States
(12) Patent Application Publication
(10) Pub. No.: US 2025/0322139 A1
(43) Pub. Date: Oct. 16, 2025

(54) METHOD FOR ESTIMATING TEMPERATURE INFORMATION OF INTEGRATED CIRCUIT DESIGN

(71) Applicant: TAIWAN SEMICONDUCTOR MANUFACTURING COMPANY LTD., HSINCHU (TW)

(72) Inventors: CHUN-WEI CHANG, TAOYUAN CITY (TW); HSIEN YU TSENG, MIAOLI COUNTY (TW); WEI-MING CHEN, HSINCHU (TW); MING-WEN LIN, HSINCHU (TW)

(21) Appl. No.: 18/632,340

(22) Filed: Apr. 11, 2024

(51) Int. Cl. G06F 30/398; G06F 119/08

(52) U.S. Cl. CPC G06F 30/398; G06F 2119/08

(57) ABSTRACT

The present disclosure provides a method for evaluating temperature information of an integrated circuit. The method includes the following steps: identifying an active region in an integrated circuit design layout; dividing the active region into a plurality of segments, wherein each segment comprises a plurality of conductors formed thereon; determining a weight of each conductor with respect to each segment; calculating a self-heat temperature increase of each conductor; and calculating a temperature increase of each segment using the weight and the self-heat temperature increase of each conductor within a valid heat-effective region of each segment.

### BACKGROUND

The flow of electric current through conductive lines can lead to a phenomenon known as electromigration (EM). Electromigration refers to the movement of metal atoms within the conductive lines due to the transfer of momentum between the electrons passing through the lines and the metal atoms themselves. As time progresses, electromigration can give rise to the formation of hillocks (e.g., accumulations of excess metal) and/or voids (e.g., areas where the initial metal has been depleted). These hillocks and voids have the potential to cause short circuits or open circuits in the wire, respectively.

### BRIEF DESCRIPTION OF THE DRAWINGS

Aspects of the present disclosure are best understood from the following detailed description when read with the accompanying figures. It is emphasized that, in accordance with standard practice in the industry, various features are not drawn to scale. In fact, the dimensions of the various features can be arbitrarily increased or reduced for clarity of discussion.

FIG. 1 is a plan view of an active region of a semiconductor structure in accordance with an embodiment of the present disclosure.

FIG. 2 is a partial plan view of the active region in FIG. 1.

FIGS. 3A-3C are partial plan views of different segments within the active region in accordance with some embodiments of the present disclosure.

FIG. 4A is a side view of a semiconductor structure with heat propagation from a specific polysilicon finger in accordance with some embodiments of the present disclosure.

FIG. 4B is a diagram illustrating temperature/heat distribution curve of the specific polysilicon finger in FIG. 4A.

FIGS. 5A and 5B are diagrams illustrating heat distribution curves generated by different polysilicon fingers within the same segment in accordance with some embodiments of the present disclosure.

FIG. 6A is a diagram of an active region with polysilicon fingers located within a central region in accordance with some embodiments of the present disclosure.

FIG. 6B is a diagram of an active region with active and dummy polysilicon fingers in accordance with some embodiments of the present disclosure.

FIG. 6C is another diagram of an active region with active and dummy polysilicon fingers in accordance with some embodiments of the present disclosure.

FIG. 6D is yet another diagram of an active region with active and dummy polysilicon fingers in accordance with some embodiments of the present disclosure.

FIG. 7 is a flow chart of an electronic design automation (EDA) flow in accordance with some embodiments of the present disclosure.

FIG. 8 is a flow chart of a method for evaluating temperature information of an integrated circuit in accordance with some embodiments of the present disclosure.

FIG. 9 is a block diagram of a computer device in accordance with some embodiments of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features can be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “over,” “upper,” “on” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Further, it will be understood that when an element is referred to as being “connected to” or “coupled to” another element, it can be directly connected to or coupled to the other element, or intervening elements can be present.

Embodiments, or examples, illustrated in the drawings are disclosed as follows using specific language. It will nevertheless be understood that the embodiments and examples are not intended to be limiting. Any alterations or modifications in the disclosed embodiments, and any further applications of the principles disclosed in this document are contemplated as would normally occur to one of ordinary skill in the pertinent art.

Further, it is understood that several processing steps and/or features of a device can be only briefly described. Also, additional processing steps and/or features can be added, and certain of the following processing steps and/or features can be removed or changed while still implementing the claims. Thus, it is understood that the following descriptions represent examples only, and are not intended to suggest that one or more steps or features are required.

In addition, the present disclosure may repeat reference numerals and/or letters in the various examples. This repetition is for the purpose of simplicity and clarity and does not in itself dictate a relationship between the various embodiments and/or configurations discussed.

Semiconductor devices experience temperature increases during operation due to self-heating effects (SHE). These effects have a detrimental impact on both the performance and operational lifespan of the affected semiconductor devices. For instance, self-heating effects in semiconductor devices like fin field effect transistors (FinFETs) lead to reduced device performance and reliability. The temperature of metal wires within an integrated circuit is influenced by various factors, with the temperature of an active region (AR) or oxide diffusion (OD) region being a significant factor. Moreover, in advanced process technologies (e.g., 2 nm or below) utilizing nanosheet super power rail (SPR) devices, the self-heating effects can be even more severe.

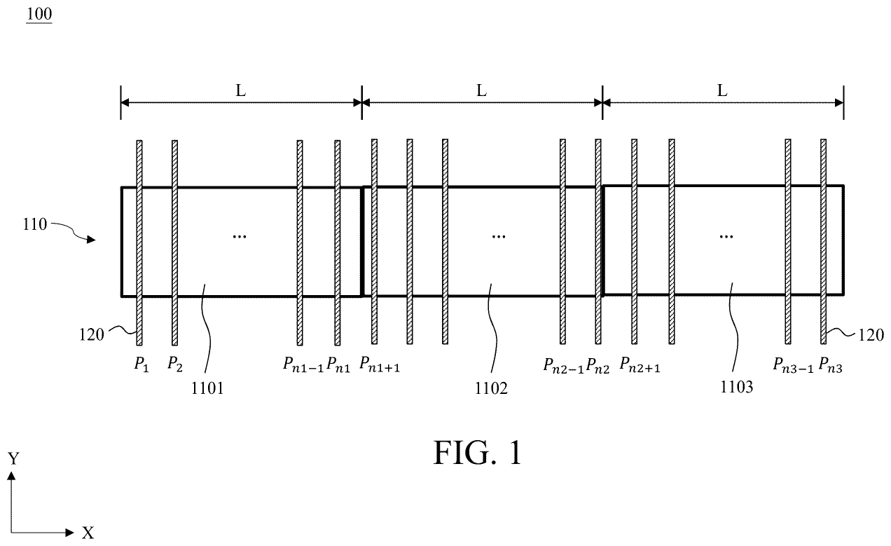

FIG. 1 is a plan view of an active region of a semiconductor structure in accordance with an embodiment of the present disclosure.

In some embodiments, the active region structure 100 (e.g., an integrated circuit design layout) may include an active region (AR) 110 and a plurality of polysilicon (poly) fingers 120. The active region 110 may be an oxide diffusion (OD) region in which transistors and other functional semiconductor device elements are formed. In some embodiments, the polysilicon fingers 120 may be active polysilicon fingers formed over the active region 110 with each polysilicon finger 120 respectively defining a transistor within the active region 110. For example, each polysilicon finger may form a gate of a PMOS transistor or an NMOS transistor within the active region 110, which includes source and drain regions.

In some embodiments, the active region 110 extends along a first direction (e.g., X-axis), while the polysilicon fingers 120 are substantially parallel and extend along a second direction (e.g., Y-axis) that is perpendicular to the first direction. Additionally, each polysilicon finger 120 has substantially the same width, and is evenly spaced apart from one another.

In some embodiments, the active region 110 may be equally divided into segments 1101, 1102, and 1103 horizontally (e.g., along the X-axis), with each segment having substantially the same width. Additionally, the polysilicon fingers 120 may be evenly distributed among segments 1101 to 1103, with each segment 1101 to 1103 having a width of L, as depicted in FIG. 1. In other words, each segment 1101 to 1103 contains an equal number of polysilicon fingers 120. For example, the polysilicon fingers 120 can be assigned with numbers ranging from 1 to n3. Specifically, the polysilicon fingers P₁ to Pₙ₁ are located within segment 1101, the polysilicon fingers Pₙ₁₊₁ to Pₙ₂ are located within segment 1102, and the polysilicon Pₙ₂₊₁ to Pₙ₃ are located within segment 1103. Here, n2=2*n1 and n3=3*n1.

In some embodiments, each segment 1101 to 1103 may have different width, and the polysilicon fingers 120 may be not evenly distributed among segments 1101 to 1103.

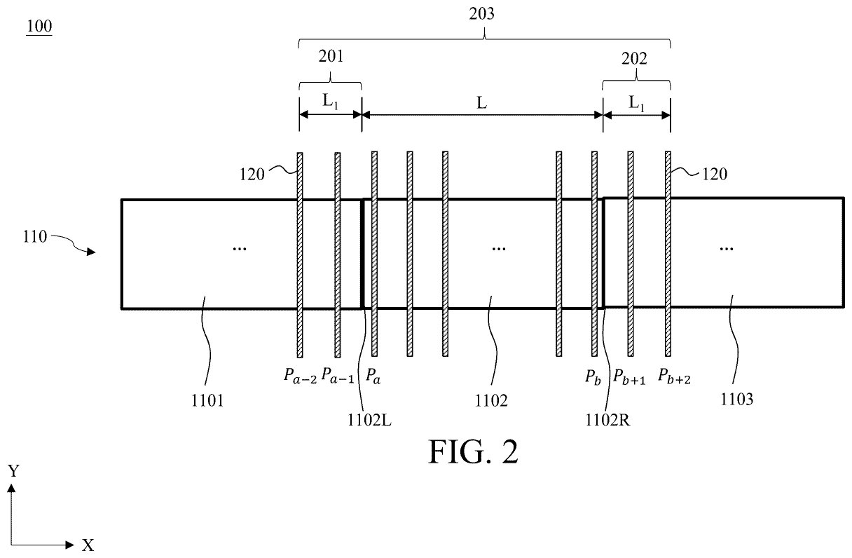

FIG. 2 is a partial plan view of the active region in FIG. 1. In some embodiments, the width L and extension width LI of each segment in the active region 110 can be defined. For example, when considering the middle segment 1102 among segments 1101 to 1103, the left extension region 201 may extend from the left edge 1102L of segment 1102 toward segment 1101 with the extension width of L₁. Similarly, the right extension region 202 may extend from the right edge 1102R of segment 1102 toward segment 1103 with the extension width of L₁. In some embodiments, while estimating the average temperature OD_dT of segment 1102, the polysilicon fingers 120 within a “valid heat-effective region 203” that includes segment 1102 and its extension regions 201 and 202 are considered. For example, the polysilicon fingers 120 numbered from Pₐ to P_{b} are within segment 1102, while the polysilicon fingers 120 numbered from Pₐ₋₂ to Pₐ₋₁ are within the left extension region 201, the polysilicon fingers 120 numbered from P_{b+1} to P_{b+2} are within the right extension region 202. Accordingly, the average temperature OD_dT of segment 1102 can be expressed by a function of the temperature and weight of each polysilicon finger 120 within the valid heat-effective region 203. Let Tₐ₋₂ to T_{b+2} respectively denote the temperature of the polysilicon fingers 120 numbered from Pₐ₋₂ to P_{b+2}, the average temperature OD_dT of segment 1102 can be expressed using formula (1) as follows.

$$OD\_dT = f ( {T}_{a - 2} , {T}_{a - 1} , {T}_{a} , … , {T}_{b} , {T}_{b + 1} , {T}_{b + 2} ) \qquad ( 1 )$$

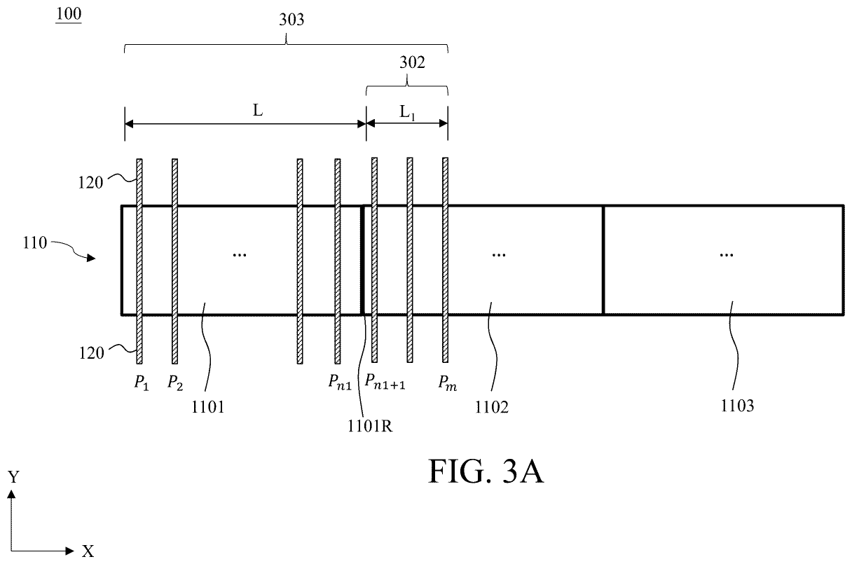

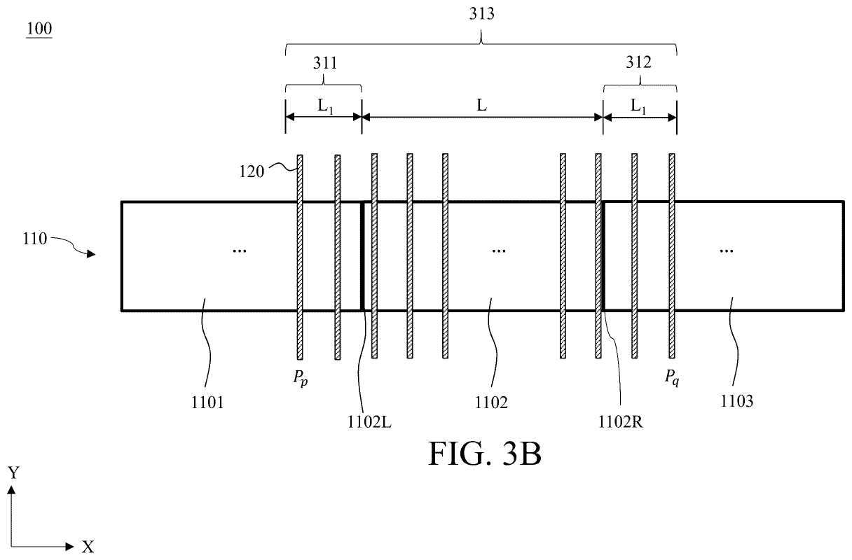

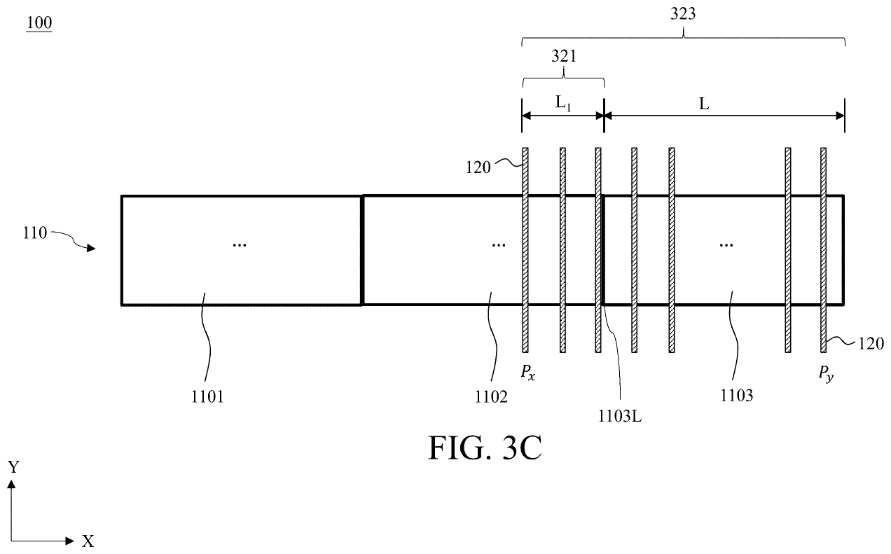

FIGS. 3A-3C are partial plan views of different segments within the active region in accordance with some embodiments of the present disclosure.

Referring to FIG. 3A, in some embodiments, segment 1101 is the left most segment among segments 1101 to 1103, with a right-side extension region 302 extending from the right edge 1101R of segment 1101 toward segment 1102 with the extension width L₁. The polysilicon fingers 120 numbered from P₁ to Pₙ₁ are within segment 1101, while the polysilicon fingers 120 numbered from Pₙ₁₊₁ to Pₘ are within the extension region 302 of segment 1101. Accordingly, m polysilicon fingers 120 (e.g., numbered from 1 to m) are within the valid heat-effective region 303 of segment 1101. In some embodiments, wi denotes the weight of the i-th polysilicon finger 120 (e.g., i is from 1 to m), while n denotes the number of polysilicon fingers 120 within segment 1101, and Poly_dT denotes the temperature of each polysilicon finger 120. Accordingly, the average temperature OD1_dT of segment 1101 can be expressed using formula (2) as follows.

$$OD1\_dT = \sqrt{\frac{{\sum }_{1}^{m} {( Poly\_dT )}^{2} * {w}_{i}}{n}} \qquad ( 2 )$$

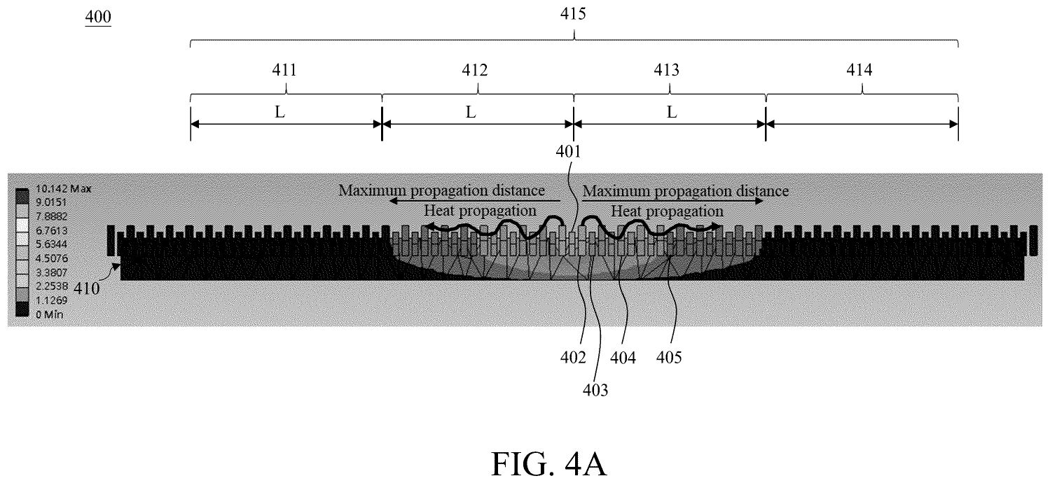

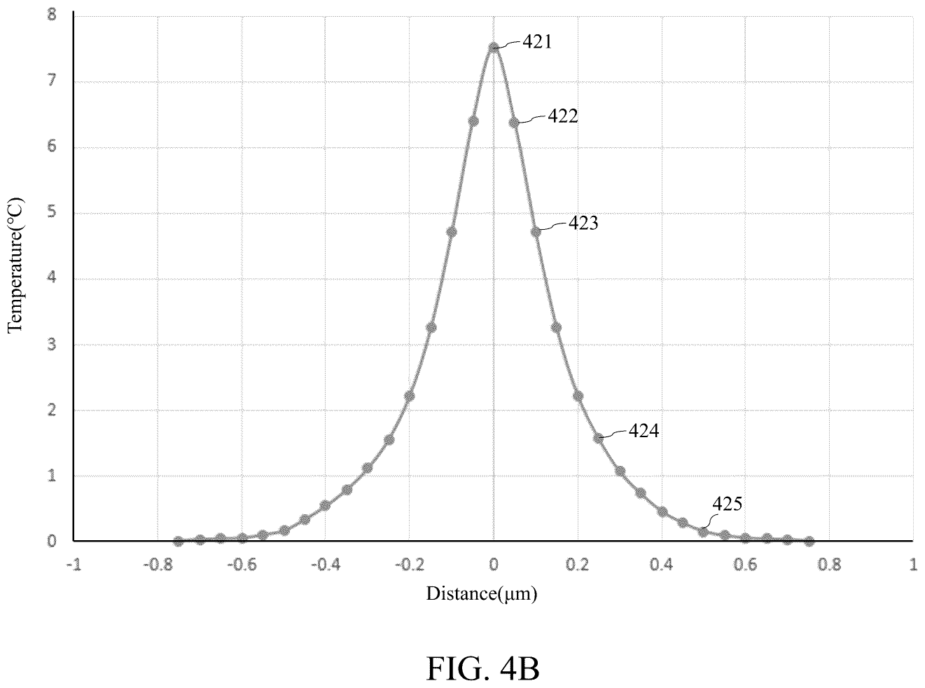

Specifically, the average temperature OD1_dT of segment 1101 can be the root mean square of the weighted temperature of each polysilicon finger 120 within the valid heat-effective region 303 of segment 1101. The details about determining the weight for each polysilicon finger 120 will be described in the embodiments of FIGS. 4A-4B.

Referring to FIG. 3B, in some embodiments, segment 1102 is the middle segment among segments 1101 to 1103, with a left-side extension region 311 extending from the left edge 1102L of segment 1102 toward segment 1101 with the extension width L₁, and a right-side extension region 312 extending from the right edge 1102R of segment 1102 toward segment 1103 with the extension width L₁. Accordingly, (p-q+1) polysilicon fingers 120 numbered from Pₚ to P_{q} are within the valid heat-effective region 313 of segment 1102. In some embodiments, wi denotes the weight of the i-th polysilicon finger 120 (e.g., i is from p to q), while n denotes the number of polysilicon fingers 120 within segment 1102, and Poly_dT denotes the temperature of each polysilicon finger 120. Accordingly, the average temperature OD2_dT of segment 1102 can be expressed using formula (3) as follows.

$$OD2\_dT = \sqrt{\frac{{\sum }_{p}^{q} {( Poly\_dT )}^{2} * {w}_{i}}{n}} \qquad ( 3 )$$

Referring to FIG. 3C, in some embodiments, segment 1103 is the right most segment among segments 1101 to 1103, with a left-side extension region 321 extending from the left edge 1103L of segment 1103 toward segment 1102 with the extension width L₁. Accordingly, (y-x+1) polysilicon fingers 120 (e.g., numbered from x to y) are within the valid heat-effective region 323 of segment 1101. In some embodiments, w; denotes the weight of the i-th polysilicon finger 120 (e.g., i is from x to y), while n denotes the number of polysilicon fingers 120 within segment 1103, and Poly_dT denotes the temperature of each polysilicon finger 120. Accordingly, the average temperature OD3_dT of segment 1103 can be expressed using formula (4) as follows.

$$OD3\_dT = \sqrt{\frac{{\sum }_{x}^{y} {( Poly\_dT )}^{2} * {w}_{i}}{n}} \qquad ( 4 )$$

It should be noted that formulas (2) and (4) described in the embodiments of FIGS. 3A and 3C are for edge segments (e.g., segments 1101 and 1103), which have a one-side extension region (e.g., extension region 302 in FIG. 3A and extension region 321 in FIG. 3C). For example, the extension region of an edge segment may extend from the inner edge of the edge segment toward the opposite side of the active region 110 with the extension width L₁. Additionally, formula (3) described in the embodiment of FIG. 3B is for non-edge segments, which have two-side extension regions (e.g., extension regions 311 and 312 in FIG. 3B). The numbers m, p, q, x, and y shown in FIGS. 3A-3C can be correlated to the actual numbers used within the active region of an integrated circuit. In some embodiments, the weight wᵢ of each polysilicon finger in formulas (2) to (4) can be set to 1.

FIG. 4A is a side view of a semiconductor structure with heat propagation from a specific polysilicon finger in accordance with some embodiments of the present disclosure. FIG. 4B is a diagram illustrating temperature/heat distribution curve the specific polysilicon finger in FIG. 4A.

As depicted in FIG. 4A, the semiconductor structure 400 may include a plurality of polysilicon fingers (e.g., polysilicon fingers 401 to 405) that are formed over a substrate 410. For example, the substrate 410 may be or comprise a semiconductor wafer such as a silicon wafer. Alternatively, the substrate 410 may include other elementary semiconductors such as germanium. The substrate 410 may also include a compound semiconductor such as silicon carbide, gallium arsenic, indium arsenide, or indium phosphide. The substrate 410 may include an alloy semiconductor such as silicon germanium, silicon germanium carbide, gallium arsenic phosphide, or gallium indium phosphide.

In some embodiments, for purposes of description, the width L of each segment 411 to 414 in the active region 414 is 1 μm, with 20 polysilicon fingers within each segment 411 to 414. That is, the interval between two adjacent polysilicon fingers is 0.05 μm. In some embodiments, when the transistor containing polysilicon finger 401 (e.g., the rightmost polysilicon finger within segment 412) is operating, the polysilicon finger 401 can generate heat and become a hot spot. This heat can then propagate towards neighboring polysilicon fingers, causing a higher temperature increment ΔT to the polysilicon fingers (e.g., 402 and 403) closer to the polysilicon finger 401, and a lower temperature increment ΔT to the polysilicon fingers (e.g., 404 and 405) farther away from the polysilicon finger 401.

Attention now is directed to FIG. 4B. Points 421 to 425 shown in FIG. 4B correspond to the locations of polysilicon fingers 401 to 405 shown in FIG. 4A. The heat generated by the polysilicon finger 401 (e.g., a hot spot) can increase its temperature by approximately 7.5° C., as shown by point 421 in FIG. 4B. It should be noted that the heat propagated to neighboring polysilicon fingers decreases with the distance from the polysilicon finger 401. For example, the heat generated by the polysilicon finger 401 can increase the temperature of the polysilicon finger 402 (e.g., 0.05 μm away from the polysilicon finger 401) by approximately 6.375° C. (e.g., about 85% of 7.5° C., as shown by point 422 in FIG. 4B), and increase the temperature of the polysilicon finger 403 (e.g., 0.1 μm away from the polysilicon finger 401) by approximately 4.69° C. (e.g., about 62.5% of 7.5° C., as shown by point 423 in FIG. 4B). Additionally, the heat generated by the polysilicon finger 401 may increase the temperature of the polysilicon finger 404 (e.g., 0.25 μm away from the polysilicon finger 401) by approximately 1.5° C. (e.g., about 20% of 7.5° C., as shown by point 424 in FIG. 4B), and increase the temperature of the polysilicon finger 405 (e.g., 0.5 μm away from the polysilicon finger 401) by approximately 0.015° C. (e.g., about 2% of 7.5° C., as shown by point 425 in FIG. 4B).

More specifically, the temperature increment of the polysilicon finger 405 contributed by the heat generated by the polysilicon finger 401 is relatively smaller than that of the polysilicon finger 401, and thus can be neglected. Accordingly, the distance from the polysilicon finger 401 (e.g., within segment 412) to the polysilicon finger 405 (e.g., within segment 413) can be used as the extension width LI of the extension region of segment 412. The extension regions of other segments within the active region 415 can have the extension width LI described.

In some embodiments, the weight of each polysilicon finger within the active region 415 can be estimated using the curve depicted in FIG. 4B. This weight can be calculated by dividing the temperature increment of each neighboring polysilicon finger with that of the reference polysilicon finger (e.g., polysilicon finger 401). For example, the weight of the polysilicon fingers 401 to 405 (e.g., corresponding to points 421 to 425) are 100%, 85%, 62.5%, 20%, and 2%, respectively. It should be noted that the weight of each polysilicon finger within segment 412 is 100% while calculating the average temperature OD_dT of segment 412. Additionally, the curve shown in FIG. 4B may be symmetric with respect to point 421, and the weights of the polysilicon fingers within segment 411 can be determined in a similar manner, based on their distance from the leftmost polysilicon finger within segment 411.

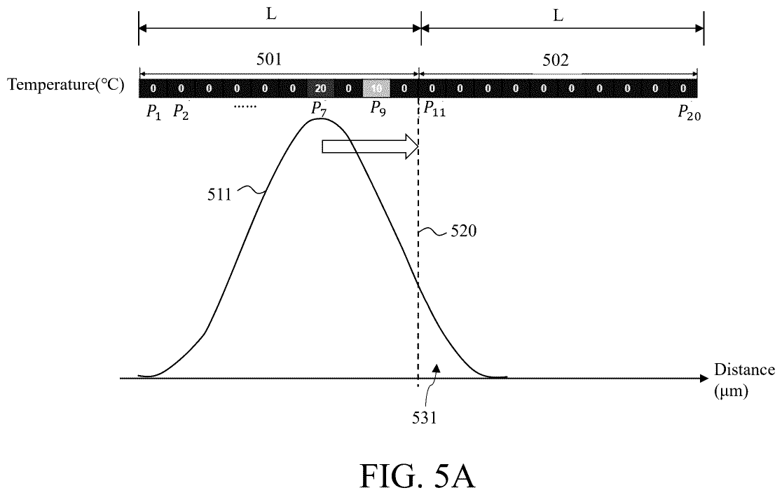

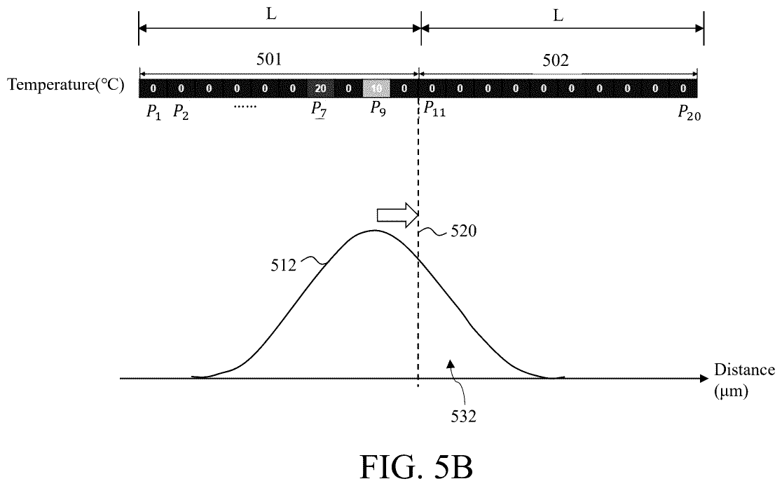

FIGS. 5A and 5B are diagrams illustrating heat distribution curves generated by different polysilicon fingers within the same segment in accordance with some embodiments of the present disclosure.

In some embodiments, 20 polysilicon fingers numbered from P1 to P20 are formed within segments 501 to 502, with 10 polysilicon fingers evenly distributed in each segment 501 to 502. Additionally, each segment 501 to 502 may have a width L substantially equal to 1 μm, and an extension width L1 substantially equal to 0.5 μm, while each polysilicon finger has a width of 0.1 μm. Referring to FIG. 5A, the polysilicon finger P7 may operate at a temperature of 20° C., and curve 511 shows its corresponding heat distribution curve. The heat propagated from the polysilicon finger P7 to segment 502 can be estimated by the area of region 531 (e.g., the region enclosed by curve 511, X-axis, and line 520), which is approximately 5% among the total area of curve 511 above the X-axis. Accordingly, the weight of the polysilicon finger P7 with respect to segment 502 can be determined as 5%.

Referring to FIG. 5B, the polysilicon finger P9 may operate at a temperature of 10° C., and curve 512 shows its corresponding heat distribution curve. The heat propagated from the polysilicon finger P9 to segment 502 can be estimated by the area of region 532 (e.g., the region enclosed by curve 512, X-axis, and line 520), which is approximately 15% among the total area between curve 511 and the X-axis. Accordingly, the weight of the polysilicon finger P9 with respect to segment 502 can be determined as 15%.

In some embodiments, segment 502, which has a width of 1 μm, includes polysilicon fingers P11 to P20, and the extension width of the extension region of segment 502 is 0.5 μm. Since the spacing between two adjacent polysilicon fingers is 0.1 μm, the extension region of segment 502 includes polysilicon fingers P6 to P10 within segment 501. Accordingly, based on the temperature information shown in FIGS. 5A-5B, the average temperature OD2_dT can be calculated using formula (5) as follows.

$$OD2\_dT = \sqrt{\frac{{\sum }_{6}^{20} {( Poly\_dT )}^{2} * {w}_{i}}{n}} = \sqrt{\frac{{20}^{2} * 5 \% + {10}^{2} * 15 \%}{10}} \approx 1.87 \qquad ( 5 )$$

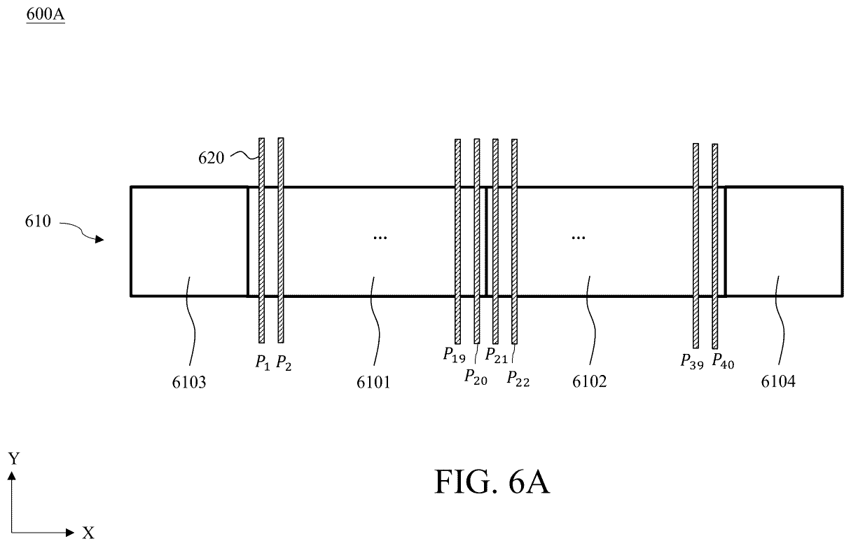

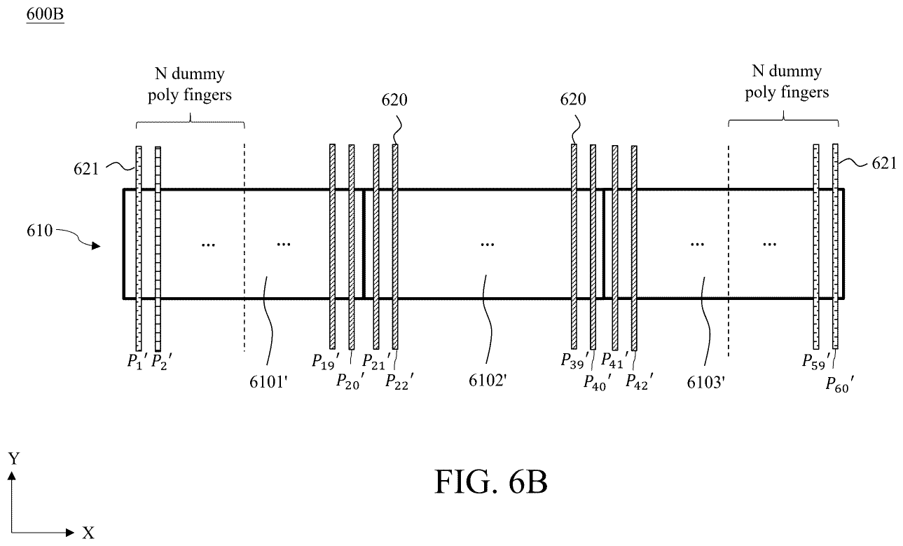

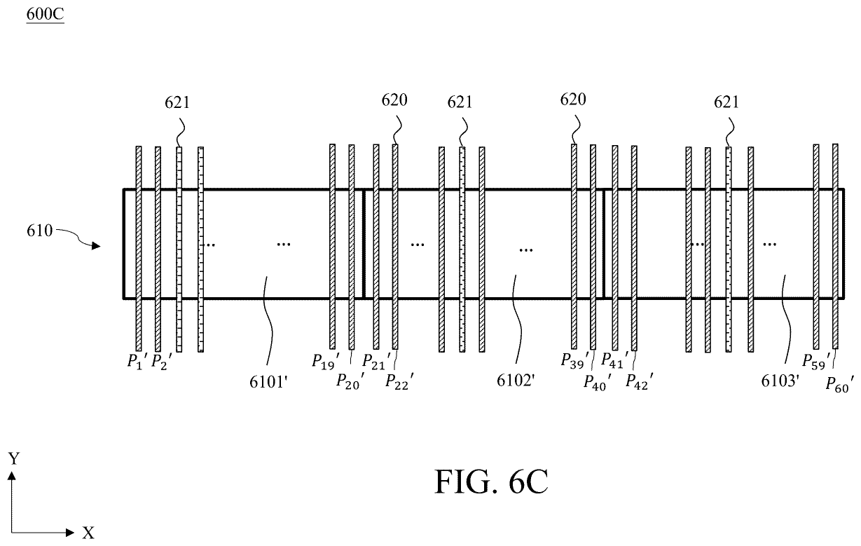

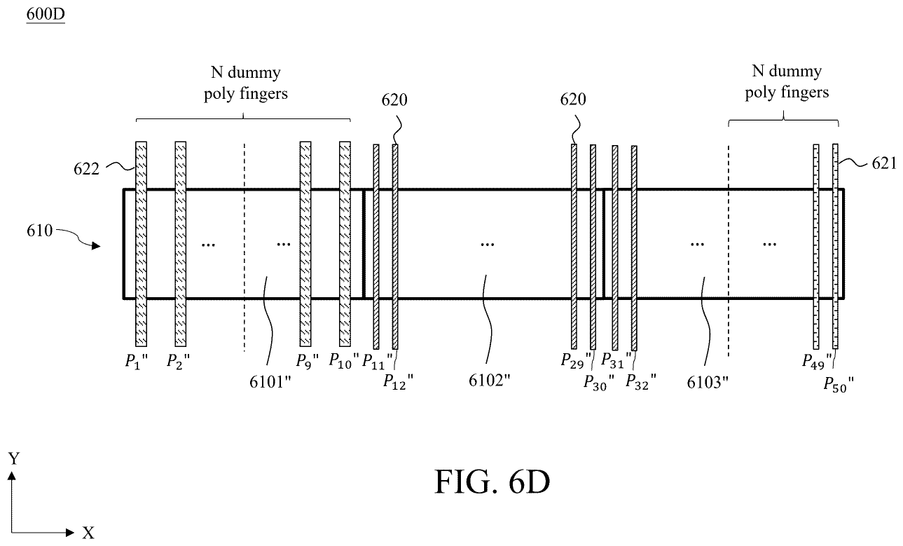

FIG. 6A is a diagram of an active region with polysilicon fingers located within a central region in accordance with some embodiments of the present disclosure.

In some embodiments, polysilicon fingers 620 numbered from P₁ to P₄₀ are formed over the active region 610 of the semiconductor structure 600A, as depicted in FIG. 6A. The polysilicon fingers 620 are distributed to segments 6101 and 6102, with each segment 6101 to 6102 having 20 polysilicon fingers 620. It should be noted that each polysilicon finger 620 can be regarded as an active polysilicon finger that forms a gate of a PMOS transistor or an NMOS transistor within the active region 610. Additionally, for purposes of description, no dummy polysilicon finger is formed on edge regions 6103 and 6104 within the active region 610. In some embodiments, each segment 6101 to 6102 may have a width L substantially equal to 1 μm, and an extension width L1 substantially equal to 0.5 μm, while the spacing between every two adjacent polysilicon fingers is 0.05 μm.

FIG. 6B is a diagram of an active region with active and dummy polysilicon fingers in accordance with some embodiments of the present disclosure. Referring to FIG. 6B, in some embodiments, N dummy polysilicon fingers 621 (e.g., N=10) may be formed on the edge regions 6103 and 6104 shown in FIG. 6A. As depicted in FIG. 6B, the polysilicon fingers 620 and the dummy polysilicon fingers 621 can be renumbered as P1′ to P60′, and the active region 610 can be divided into segments 6101′ to 6103′, with each segment 6101′ to 6103′ having 20 polysilicon fingers 620 and/or 621. It should be noted that the dummy polysilicon fingers 621 may be formed for the purpose of temperature estimation of the active region or its segments, and no transistors are formed on the active region 610 using the dummy polysilicon fingers 621. Additionally, the width of each dummy polysilicon finger 621 may be substantially the same as that of each polysilicon finger 620. Similarly, each segment 6101′ to 6103′ may have a width L substantially equal to 1 μm, and an extension width LI substantially equal to 0.5 μm, while the spacing between every two adjacent polysilicon fingers is 0.05 μm.

FIG. 6C is another diagram of an active region with active and dummy polysilicon fingers in accordance with some embodiments of the present disclosure. Referring to FIG. 6C, in some embodiments, one or more dummy polysilicon fingers 621 may be formed within any location of the active region 610, depending on the design of the semiconductor structure 600C. For purposes of description, the total number of polysilicon fingers 620 and dummy polysilicon fingers 621 may be 60. Similarly, the polysilicon fingers 620 and the dummy polysilicon fingers 621 can be renumbered as P1′ to P60′, and the active region 610 can be divided into segments 6101′ to 6103′, with each segment 6101′ to 6103′ having 20 polysilicon fingers 620 and/or 621. Similarly, each segment 6101′ to 6103′ may have a width L substantially equal to 1 μm, and an extension width L1 substantially equal to 0.5 μm, while the spacing between every two adjacent polysilicon fingers is 0.05 μm.

FIG. 6D is yet another diagram of an active region with active and dummy polysilicon fingers in accordance with some embodiments of the present disclosure. Referring to FIG. 6D, in some embodiments, N dummy polysilicon fingers 622 and N dummy polysilicon fingers 621 (e.g., N=10) may be formed on the edge regions 6103 and 6104 shown in FIG. 6A. Each dummy polysilicon finger 622 has twice the width of each polysilicon finger 620 and 621. As depicted in FIG. 6D, the polysilicon fingers 620 and the dummy polysilicon fingers 621 can be renumbered as P1″ to P50″, and the active region 610 can be divided into segments 6101″ to 6103″. Segment 6101″ includes 10 polysilicon fingers 622, while each segment 6102″ to 6103″ includes 20 polysilicon fingers 620 and/or 621. It should be noted that the width of segment 6101″ is substantially the same as that of segments 6102″ to 6103″ (e.g., 1 μm), and the spacing between two adjacent polysilicon fingers 622 may be 0.1 μm which is twice the spacing between two adjacent polysilicon fingers 620 or 621.

In some embodiments, the weight wᵢ of each polysilicon finger with respect to a particular segment of the active region may depend on the several factors: (1) the heat distribution curve of each polysilicon finger; (2) the distance of each polysilicon finger from the center or edge of the particular segment; (3) the type of each polysilicon finger; (4) the location of each polysilicon finger; and (5) the width of each polysilicon finger.

In some embodiments, the heat distribution curve (e.g., curves 511 and 512 shown in FIGS. 5A-5B) of each polysilicon finger within the active region can be simulated using computer-aided analysis/engineering (CAA/CAE) tools. This allows for the measurement of the contribution to the temperature increase of the particular segment caused by each polysilicon finger, enabling the determination of the weight of each polysilicon finger. In addition, as described in the embodiments of FIGS. 4A-4B, the weight of each polysilicon finger can be determined based on its distance from the closest edge polysilicon finger within the particular segment. Specifically, the heat generated by each polysilicon finger decreases as it propagates to neighboring polysilicon fingers with increasing distance from the edge polysilicon finger within the particular segment.

In some embodiments, the weight of each polysilicon finger with respect to the particular segment can be adjusted based on its type, whether it is active or dummy. For example, an active polysilicon finger generates heat while a dummy one does not, so the weight of a dummy finger can be set lower than that of an active finger in the same location. In some embodiments, the weight of each polysilicon finger with respect to the particular segment may also be affected by its location. For example, polysilicon fingers located at the edge or middle of the active region may have different weights, and this concept can be derived from the heat distribution curve mentioned earlier. In some embodiments, the polysilicon fingers can have different widths in some technologies. A wider polysilicon finger generates more heat and causes a greater temperature increase in the particular segment compared to a narrower one. Consequently, polysilicon fingers with larger widths may be assigned higher weights, while those with smaller widths may be assigned lower weights.

Attention now is directed back to FIG. 6A again. In some embodiments, the number PFN and temperature of each polysilicon finger within segment 6101 are shown in Table 1-1 while those within segment 6102 are shown in Table 1-2.

TABLE 1-1

| PFN | 1 | 2 | 3 | 4 | 5 | 6 | 7 | 8 | 9 | 10 | 11 | 12 | 13 | 14 | 15 | 16 | 17 | 18 | 19 | 20 |
|---|---|---|---|---|---|---|---|---|---|---|---|---|---|---|---|---|---|---|---|---|
| T(° C.) | 0 | 0 | 0 | 0 | 0 | 0 | 0 | 0 | 5 | 10 | 11 | 12 | 13 | 14 | 15 | 16 | 17 | 18 | 19 | 20 |

TABLE 1-2

| PFN | 21 | 22 | 23 | 24 | 25 | 26 | 27 | 28 | 29 | 30 | 31 | 32 | 33 | 34 | 35 | 36 | 37 | 38 | 39 | 40 |
|---|---|---|---|---|---|---|---|---|---|---|---|---|---|---|---|---|---|---|---|---|
| T(° C.) | 19 | 18 | 17 | 16 | 15 | 14 | 13 | 12 | 11 | 10 | 5 | 0 | 0 | 0 | 0 | 0 | 0 | 0 | 0 | 0 |

Segments 6101 and 6102 are considered edge segments, meaning that temperature information of the polysilicon fingers within the extension regions can be taken into account when calculating their average temperatures. Formulas (2) and (4) with wᵢ being 1 are used for this calculation, resulting in average temperatures OD1_dT and OD2_dT of 12.75° C. and 12.39° C., respectively. However, if the temperature information of the polysilicon fingers outside the particular segment is not considered (i.e., no extension region is taken into account), a different approach can be used to calculate the average temperatures. In this particular approach, the calculated average temperatures OD1_dT′ and OD2_dT′ are 11.42° C. and 10.51° C., respectively. Since the hottest polysilicon fingers (hot spots) are located in the middle of the active region 610, this particular approach divides them into segments 6101 and 6102. However, the average temperatures OD1_dT′ and OD2_dT′ calculated by this approach do not accurately reflect the actual average temperatures of segments 6101 and 6102. On the other hand, the methodology proposed in this disclosure takes into account the temperature information of the polysilicon fingers within the extension regions outside segments 6101 and 6102. As a result, the average temperatures OD1_dT′ and OD2_dT′ calculated by this proposed methodology provide a more precise reflection of the actual average temperatures of segments 6101 and 6102.

Attention now is directed back to FIG. 6B again. In some embodiments, the number PFN′ and temperature (° C.) of each polysilicon finger within segments 6101′, 6102′, and 6103′ are shown in Tables 2-1, 2-2, and 2-3, respectively.

TABLE 2-1

| PFN′ | 1 | 2 | 3 | 4 | 5 | 6 | 7 | 8 | 9 | 10 | 11 | 12 | 13 | 14 | 15 | 16 | 17 | 18 | 19 | 20 |
|---|---|---|---|---|---|---|---|---|---|---|---|---|---|---|---|---|---|---|---|---|
| T(° C.) | 0 | 0 | 0 | 0 | 0 | 0 | 0 | 0 | 0 | 0 | 0 | 0 | 0 | 0 | 0 | 0 | 0 | 0 | 5 | 10 |

TABLE 2-2

| PFN′ | 21 | 22 | 23 | 24 | 25 | 26 | 27 | 28 | 29 | 30 | 31 | 32 | 33 | 34 | 35 | 36 | 37 | 38 | 39 | 40 |
|---|---|---|---|---|---|---|---|---|---|---|---|---|---|---|---|---|---|---|---|---|
| T(° C.) | 11 | 12 | 13 | 14 | 15 | 16 | 17 | 18 | 19 | 20 | 19 | 18 | 17 | 16 | 15 | 14 | 13 | 12 | 11 | 10 |

TABLE 2-3

| PFN′ | 41 | 42 | 43 | 44 | 45 | 46 | 47 | 48 | 49 | 50 | 51 | 52 | 53 | 54 | 35 | 56 | 57 | 58 | 59 | 60 |
|---|---|---|---|---|---|---|---|---|---|---|---|---|---|---|---|---|---|---|---|---|
| T(° C.) | 5 | 0 | 0 | 0 | 0 | 0 | 0 | 0 | 0 | 0 | 0 | 0 | 0 | 0 | 0 | 0 | 0 | 0 | 0 | 0 |

In some embodiments, the polysilicon fingers at 0° C. can be considered as dummy polysilicon fingers. Formulas (2) to (4) with wᵢ being 1 can be used to calculate the average temperatures OD1_dT, OD2_dT, and OD3_dT of segments 6101′, 6102′, and 6103′, respectively, taking into account the temperature information of the polysilicon fingers within the extension regions. The calculated average temperatures OD1_dT, OD2_dT, and OD3_dT are 6.26° C., 12.68° C., and 5.50° C., respectively. Alternatively, in a particular approach that calculates the average temperature of a particular segment without considering the temperature information of polysilicon fingers outside that segment (i.e., no extension region is considered), the calculated average temperatures OD1_dT′, OD2_dT′, and OD3_dT′ are 2.5° C., 15.28° C., and 1.12° C., respectively. It is worth noting that the highest average temperature among segments 6101′ to 6103′ is 15.28° C. using the particular approach, which is higher than the highest average temperature among segments 6101 to 6102, even though dummy polysilicon fingers are added to cool down the segments. On the other hand, the proposed methodology for calculating the average temperature OD1_dT takes into account the heat (or temperatures) of the polysilicon fingers numbered P₂₁ to P₂₅ within segment 6102′, which propagate to segment 6101′. Therefore, the average temperature OD1_dT calculated using the proposed methodology is more accurate than that calculated using the particular approach. Furthermore, the polysilicon fingers numbered P₁ to P₂₀ and P₄₁ to P₆₀ are designed as dummy polysilicon fingers to cool down the middle segment 6102′. As a result, the average temperature OD2_dT calculated using the proposed methodology is lower than that calculated using the specific approach, providing a better reflection of the actual average temperature of segment 6102′.

Attention now is directed back to FIG. 6A again. In some embodiments, the number PFN and temperature of each polysilicon finger within segment 6101 are shown in Table 3-1 while those within segment 6102 are shown in Table 3-2.

TABLE 3-1

| PFN | 1 | 2 | 3 | 4 | 5 | 6 | 7 | 8 | 9 | 10 | 11 | 12 | 13 | 14 | 15 | 16 | 17 | 18 | 19 | 20 |
|---|---|---|---|---|---|---|---|---|---|---|---|---|---|---|---|---|---|---|---|---|
| T(° C.) | 0 | 0 | 5 | 10 | 15 | 20 | 25 | 25 | 25 | 25 | 20 | 15 | 10 | 5 | 10 | 0 | 0 | 0 | 0 | 0 |

TABLE 3-2

| PFN | 21 | 22 | 23 | 24 | 25 | 26 | 27 | 28 | 29 | 30 | 31 | 32 | 33 | 34 | 35 | 36 | 37 | 38 | 39 | 40 |
|---|---|---|---|---|---|---|---|---|---|---|---|---|---|---|---|---|---|---|---|---|
| T(° C.) | 0 | 0 | 0 | 0 | 0 | 0 | 0 | 0 | 5 | 10 | 15 | 20 | 20 | 20 | 15 | 10 | 5 | 0 | 0 | 0 |

In some embodiments, segments 6101 and 6102 are considered edge segments, and formulas (2) and (4) with wᵢ being 1 can be used to calculate average temperatures OD1_dT and OD2_dT of segments 6101 and 6102 as 12.65° C. and 8.72° C., respectively. However, if the temperature information of the polysilicon fingers outside the particular segment is not considered (i.e., no extension region is taken into account), a different approach can be used to calculate the average temperatures. In this particular approach, the calculated average temperatures OD1_dT′ and OD2_dT′ are 14.14° C. and 9.75° C., respectively. Furthermore, 20 dummy polysilicon fingers can be added between segments 6101 and 6102 to cool down segments 6101 and 6102, with a total number of 60 polysilicon fingers. Referring to FIG. 6C, the active region 610 can be re-divided into segments 6101′ to 6103′, with each segment 6101′ to 6103′ having 20 polysilicon fingers. Additionally, the polysilicon fingers 620 and 621 are renumbered from P₁′ to P₆₀′, the number PFN′ and temperature (° C.) of each polysilicon finger within segments 6101′, 6102′, and 6103′ are shown in Tables 4-1, 4-2, and 4-3, respectively.

TABLE 4-1

| PFN′ | 1 | 2 | 3 | 4 | 5 | 6 | 7 | 8 | 9 | 10 | 11 | 12 | 13 | 14 | 15 | 16 | 17 | 18 | 19 | 20 |
|---|---|---|---|---|---|---|---|---|---|---|---|---|---|---|---|---|---|---|---|---|
| T(° C.) | 0 | 0 | 5 | 10 | 15 | 20 | 25 | 25 | 25 | 25 | 20 | 15 | 10 | 5 | 0 | 0 | 0 | 0 | 0 | 0 |

TABLE 4-2

| PFN′ | 21 | 22 | 23 | 24 | 25 | 26 | 27 | 28 | 29 | 30 | 31 | 32 | 33 | 34 | 35 | 36 | 37 | 38 | 39 | 40 |
|---|---|---|---|---|---|---|---|---|---|---|---|---|---|---|---|---|---|---|---|---|
| T(° C.) | 0 | 0 | 0 | 0 | 0 | 0 | 0 | 0 | 0 | 0 | 0 | 0 | 0 | 0 | 0 | 0 | 0 | 0 | 0 | 0 |

TABLE 4-3

| PFN′ | 41 | 42 | 43 | 44 | 45 | 46 | 47 | 48 | 49 | 50 | 51 | 52 | 53 | 54 | 35 | 56 | 57 | 58 | 59 | 60 |
|---|---|---|---|---|---|---|---|---|---|---|---|---|---|---|---|---|---|---|---|---|
| T(° C.) | 0 | 0 | 0 | 0 | 0 | 0 | 0 | 0 | 5 | 10 | 15 | 20 | 20 | 20 | 15 | 10 | 5 | 0 | 0 | 0 |

In some embodiments, the polysilicon fingers at 0° C. can be considered as dummy polysilicon fingers. Formulas (2) to (4) with wᵢ being 1 can be used to calculate the average temperatures OD1_dT, OD2_dT, and OD3_dT of segments 6101′, 6102′, and 6103′, respectively, taking into account the temperature information of the polysilicon fingers within the extension regions. The calculated average temperatures OD1_dT, OD2_dT, and OD3_dT are 12.40° C., 5.24° C., and 7.96° C., respectively. Alternatively, in a particular approach that calculates the average temperature of a particular segment without considering the temperature information of polysilicon fingers outside that segment (i.e., no extension region is considered), the calculated average temperatures OD1_dT′, OD2_dT′, and OD3_dT′ are 14.14° C., 0° C., and 9.75° C., respectively. More specifically, both segments 6101 and 6102 include hot spots (e.g., polysilicon fingers P7 to P10 and P52 to P54). Even though the dummy polysilicon fingers P21′ to P40′ are added to cool down segments 6101 and 6102, the calculated average temperature OD1_dT′ of segment 6101′ is the same as the calculated OD1_dT′ of segment 6101 using the particular approach, which does not reflect the actual average temperature of segment 6101′. On the other hand, the methodology proposed in this disclosure takes into account the temperature information of the polysilicon fingers within the extension regions outside segments 6101 and 6102. As a result, the average temperatures OD1_dT′ and OD3_dT′ calculated by this proposed methodology provide a more precise reflection of the actual average temperatures of segments 6101′ and 6103′.

Following the embodiments of Tables 2-1 to 2-3, the number PFN′, temperature (° C.), weight W(%), and distance D(μm) to segment 6102′ of each polysilicon finger within segments 6101′, 6102′, and 6103′ are shown in Tables 5-1, 5-2, and 5-3, respectively.

TABLE 5-1

| PFN′ | 1 | 2 | 3 | 4 | 5 | 6 | 7 | 8 | 9 | 10 | 11 | 12 | 13 | 14 | 15 | 16 | 17 | 18 | 19 | 20 |
|---|---|---|---|---|---|---|---|---|---|---|---|---|---|---|---|---|---|---|---|---|
| T(° C.) | 0 | 0 | 0 | 0 | 0 | 0 | 0 | 0 | 0 | 0 | 0 | 0 | 0 | 0 | 0 | 0 | 0 | 0 | 5 | 10 |
| W(%) | 0 | 0 | 0 | 0 | 0 | 0 | 0 | 0 | 0 | 0 | 2 | 5 | 8 | 10 | 15 | 20 | 27 | 41 | 62.5 | 85 |
| D(μm) | 1 | 0.95 | 0.9 | 0.85 | 0.8 | 0.75 | 0.7 | 0.65 | 0.6 | 0.55 | 0.5 | 0.45 | 0.4 | 0.35 | 0.3 | 0.25 | 0.2 | 0.15 | 0.1 | 0.05 |

TABLE 5-2

| PFN′ | 21 | 22 | 23 | 24 | 25 | 26 | 27 | 28 | 29 | 30 |
|---|---|---|---|---|---|---|---|---|---|---|
| T(° C.) | 11 | 12 | 13 | 14 | 15 | 16 | 17 | 18 | 19 | 20 |
| W(%) | 100 | 100 | 100 | 100 | 100 | 100 | 100 | 100 | 100 | 100 |
| D(μm) | 0 | 0 | 0 | 0 | 0 | 0 | 0 | 0 | 0 | 0 |

| PFN′ | 31 | 32 | 33 | 34 | 35 | 36 | 37 | 38 | 39 | 40 |
|---|---|---|---|---|---|---|---|---|---|---|
| T(° C.) | 19 | 18 | 17 | 16 | 15 | 14 | 13 | 12 | 11 | 10 |
| W(%) | 100 | 100 | 100 | 100 | 100 | 100 | 100 | 100 | 100 | 100 |
| D(μm) | 0 | 0 | 0 | 0 | 0 | 0 | 0 | 0 | 0 | 0 |

TABLE 5-3

| PFN′ | 41 | 42 | 43 | 44 | 45 | 46 | 47 | 48 | 49 | 50 | 51 | 52 | 53 | 54 | 35 | 56 | 57 | 58 | 59 | 60 |
|---|---|---|---|---|---|---|---|---|---|---|---|---|---|---|---|---|---|---|---|---|
| T(° C.) | 5 | 0 | 0 | 0 | 0 | 0 | 0 | 0 | 0 | 0 | 0 | 0 | 0 | 0 | 0 | 0 | 0 | 0 | 0 | 0 |
| W(%) | 85 | 62.5 | 41 | 27 | 20 | 15 | 10 | 8 | 5 | 2 | 0 | 0 | 0 | 0 | 0 | 0 | 0 | 0 | 0 | 0 |
| D(μm) | 0.05 | 0.1 | 0.15 | 0.2 | 0.25 | 0.3 | 0.35 | 0.4 | 0.45 | 0.5 | 0.55 | 0.6 | 0.65 | 0.7 | 0.75 | 0.8 | 0.85 | 0.9 | 0.95 | 1 |

In some embodiments, the polysilicon fingers at 0° C. can be considered as dummy polysilicon fingers. Formulas (2) to (4) with respective weight wᵢ of each polysilicon finger can be used to calculate the average temperatures OD1_dT, OD2_dT, and OD3_dT of segments 6101′, 6102′, and 6103′, respectively, taking into account the temperature information of the polysilicon fingers within the extension regions. For example, polysilicon fingers P₁₁′ to P₂₀′ and P₄₁′ to P₅₀′ are within the left extension region and right extension region of segment 6102′, respectively. The average temperature OD2_dT′ of segment 6102′ can be calculated using formula (3) with p=11 and q=50. Similarly, the average temperature OD1_dT′ of segment 6101′ can be calculated using formula (2) with m=30, while the average temperature OD3_dT′ of segment 6103′ can be calculated using formula (4) with x=31 and y=60. Accordingly, the calculated average temperatures OD1_dT′, OD2_dT′, and OD3_dT′ are 5.5° C., 15.78° C., and 4.67° C., respectively, providing a better reflection of the actual average temperatures of segments 6101′ to 6103′ with the respective weight of each polysilicon finger being considered.

Attention now is directed back to FIG. 6D. In some embodiments, the number PFN″, temperature (° C.), weight W(%), and distance D(μm) to segment 6102″ of each polysilicon finger within segments 6101″, 6102″, and 6103″ are shown in Tables 6-1, 6-2, and 6-3, respectively.

TABLE 6-1

| PFN″ | 1 | 2 | 3 | 4 | 5 | 6 | 7 | 8 | 9 | 10 |
|---|---|---|---|---|---|---|---|---|---|---|
| T(° C.) | 0 | 0 | 0 | 0 | 0 | 0 | 0 | 0 | 0 | 8 |
| W(%) | 0 | 0 | 0 | 0 | 0 | 0 | 0 | 0 | 0 | 0 |
| D(μm) | 1 | 0.9 | 0.8 | 0.7 | 0.6 | 0.5 | 0.4 | 0.3 | 0.2 | 0.1 |

TABLE 6-2

| PFN″ | 11 | 12 | 13 | 14 | 15 | 16 | 17 | 18 | 19 | 20 |
|---|---|---|---|---|---|---|---|---|---|---|
| T(° C.) | 11 | 12 | 13 | 14 | 15 | 16 | 17 | 18 | 19 | 20 |
| W(%) | 100 | 100 | 100 | 100 | 100 | 100 | 100 | 100 | 100 | 100 |
| D(μm) | 0 | 0 | 0 | 0 | 0 | 0 | 0 | 0 | 0 | 0 |

| PFN″ | 21 | 22 | 23 | 24 | 25 | 26 | 27 | 28 | 29 | 30 |
|---|---|---|---|---|---|---|---|---|---|---|
| T(° C.) | 19 | 18 | 17 | 16 | 15 | 14 | 13 | 12 | 11 | 10 |
| W(%) | 100 | 100 | 100 | 100 | 100 | 100 | 100 | 100 | 100 | 100 |
| D(μm) | 0 | 0 | 0 | 0 | 0 | 0 | 0 | 0 | 0 | 0 |

TABLE 6-3

| PFN″ | 31 | 32 | 33 | 34 | 35 | 36 | 37 | 38 | 39 | 40 | 41 | 42 | 43 | 44 | 45 | 46 | 47 | 48 | 49 | 50 |
|---|---|---|---|---|---|---|---|---|---|---|---|---|---|---|---|---|---|---|---|---|
| T(° C.) | 5 | 0 | 0 | 0 | 0 | 0 | 0 | 0 | 0 | 0 | 0 | 0 | 0 | 0 | 0 | 0 | 0 | 0 | 0 | 0 |
| W(%) | 85 | 62.5 | 41 | 27 | 20 | 15 | 10 | 8 | 5 | 2 | 0 | 0 | 0 | 0 | 0 | 0 | 0 | 0 | 0 | 0 |
| D(μm) | 0.05 | 0.1 | 0.15 | 0.2 | 0.25 | 0.3 | 0.35 | 0.4 | 0.45 | 0.5 | 0.55 | 0.6 | 0.65 | 0.7 | 0.75 | 0.8 | 0.85 | 0.9 | 0.95 | 1 |

In some embodiments, the polysilicon fingers at 0° C. can be considered as dummy polysilicon fingers. Formulas (2) to (4) with respective weight wᵢ of each polysilicon finger can be used to calculate the average temperatures OD1_dT ″, OD2_dT″, and OD3_dT″ of segments 6101″, 6102″, and 6103″, respectively, taking into account the temperature information of the polysilicon fingers within the extension regions. For example, polysilicon fingers P₆″ to P₁₀″ and P₃₁″ to P₄₀″ are within the left extension region and right extension region of segment 6102″, respectively. The average temperature OD2_dT″ of segment 6102″ can be calculated using formula (3) with p=11 and q=40. It should be noted that since each dummy polysilicon finger 622 has twice the width of each polysilicon finger 620 and 621, the weight of each polysilicon finger 622 is also twice the weight of each polysilicon finger 620 and 621. Additionally, if each dummy polysilicon finger 622 has N times the width of each polysilicon finger 620 and 621, the weight of each polysilicon finger 622 is also N times the weight of each polysilicon finger 620 and 621, where N can be an arbitrary number complying with the design rules of the integrated circuit. Similarly, the average temperature OD1_dT″ of segment 6101″ can be calculated using formula (2) with m=20, while the average temperature OD3_dT″ of segment 6103″ can be calculated using formula (4) with x=21 and y=50. Accordingly, the calculated average temperatures OD1_dT “, OD2_dT”, and OD3_dT″ are 5.51° C., 15.47° C., and 4.67° C., respectively, providing a better reflection of the actual average temperatures of segments 6101″ to 6103″ with the respective weight of each polysilicon finger being considered.

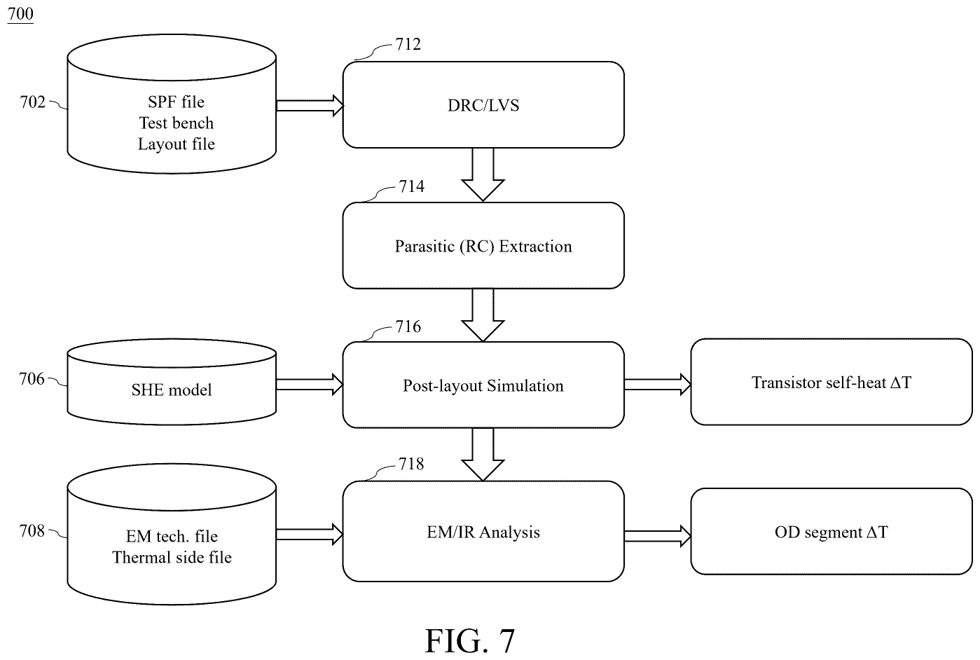

FIG. 7 is a flow chart of an electronic design automation (EDA) flow in accordance with some embodiments of the present disclosure.

In some embodiments, the flow 700 shown in FIG. 7 may refer to an EDA post-sim procedure. In operation 712, a design-rule check (DRC) and layout versus schematic (LVS) procedure is performed using a library 702 containing a standard test interface language (STIL) procedure file (e.g., a.spf file), one or more test benches, and a layout file. The layout file may include a layout of an integrated circuit, and the current formats for layout files may include, but are not limited to GDS II and OASIS. The STIL procedure file may describe test pins, voltage specification, timing specification, and test pattern (e.g., including the one or more test benches) of the integrated circuit.

After successfully completing the LVS and DRC procedure, in operation 714, a parasitic (e.g., resistance and capacitance (RC)) extraction procedure is performed to calculate the parasitic effects in both the designed devices and wiring interconnects of the integrated circuit. These parasitic effects include resistance, capacitance, and inductance, which can significantly impact the performance and functionality of the IC. By analyzing the layout of the IC, the physical characteristics of the interconnects and devices are determined, and an accurate representation of the parasitic effects in the IC design is created. The extracted parasitic data, in formats such as a standard parasitic format (.SPF), a standard parasitic exchange format (.SPEF), a reduced standard parasitic format (.RSPF), a detailed standard parasitic format (.DSPF), etc., can be used in subsequent steps of the design process, such as timing analysis, signal integrity analysis, and power analysis. Parasitic extraction is crucial in modern IC design as it helps designers identify and mitigate potential issues caused by parasitic effects. By accurately modeling these effects, designers can optimize the performance, power consumption, and reliability of the IC.

Once the parasitic extraction procedure being completed, in operation 716, a post-layout simulation is performed using the parasitic file generated by the parasitic extraction procedure and a library 706 including a self-heating effect (SHE) model. The SHE model, which may be a simulation program with integrated circuit emphasis (SPICE) model, estimates the self-heat temperature increase ΔT of each transistor or polysilicon finger within the integrated circuit.

Following the post-layout simulation, an electromigration (EM) and voltage (IR) drop analysis procedure is performed using a library 708 including an EM technology file and a thermal side file. The thermal side file may record the heat distribution curves (or weights) of each polysilicon finger within the active region of the integrated circuit with respect to different AR/OD segments of the active region. This allows the EDA tool to provide a more precise temperature estimation result of each AR/OD segment, such as an AR/OD temperature increase ΔT of each AR/OD segment. In some embodiments, electromigration (EM) rules for EM analysis are highly dependent on the temperature of metal wires. For example, the EM limit can decrease by 50% with a temperature increase of 10° C. Therefore, incorporating the temperature estimation result of each AR/OD segment generated by the proposed methodology can enhance the EM evaluation result.

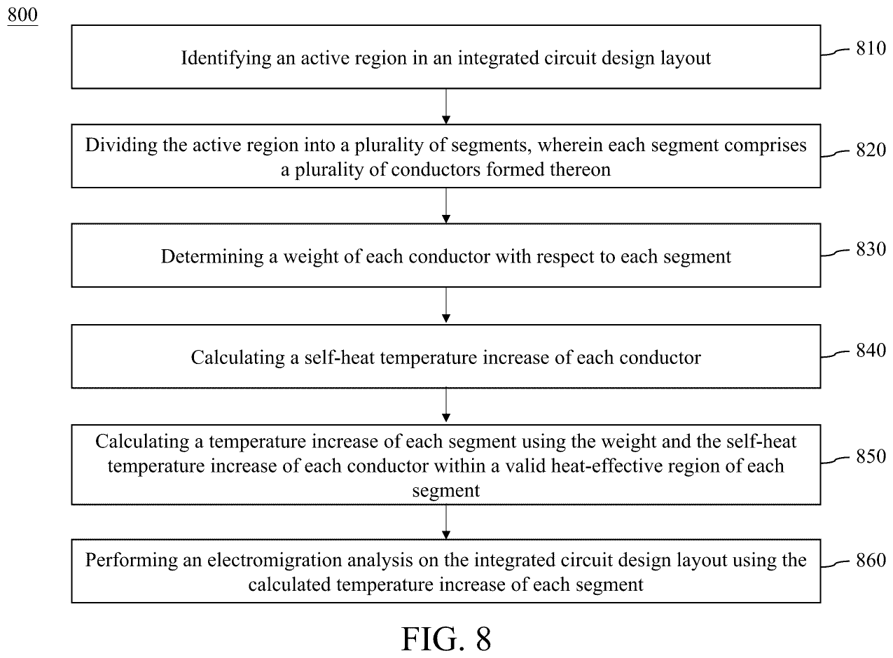

FIG. 8 is a flow chart of a method for evaluating temperature information of an integrated circuit in accordance with some embodiments of the present disclosure. Please refer to FIG. 2 and FIG. 8.

In operation 810, an active region of an integrated circuit design layout is identified. In some embodiments, the active region may be an oxide diffusion (OD) region in which transistors and other functional semiconductor device elements of the integrated circuit design are formed.

In operation 820, the active region divided into a plurality of segments, wherein each segment includes a plurality of conductors formed thereon. For example, the conductors may be polysilicon fingers 120 shown in FIG. 2, or polysilicon fingers 620 to 622 shown in FIGS. 6A-6C. In some embodiments, the polysilicon fingers may include active polysilicon fingers and dummy polysilicon fingers having substantially the same width. In some embodiments, the polysilicon fingers may include active polysilicon fingers and dummy polysilicon fingers, and a portion of the active polysilicon fingers or dummy polysilicon fingers may have a width different from other polysilicon fingers.

In operation 830, a weight of each conductor with respect to each segment is determined. In some embodiments, the weight of each conductor with respect to each segment can be determined using a heat distribution curve of each conductor with respect to each segment. In some embodiments, the heat distribution curve of each conductor with respect to each segment can be measured by the quality-and-reliability (QR) department in the foundry that manufactures the integrated circuit.

In operation 840, a self-heat temperature increase of each conductor is calculated. In some embodiments, a post-layout simulation can be performed using the parasitic file generated by the parasitic extraction procedure and a self-heating effect (SHE) model. This allows to estimate the self-heat temperature increase ΔT of each conductor (e.g., polysilicon finger) within the integrated circuit.

In operation 850, a temperature increase of each segment is calculated (e.g., a first EM analysis) using the weight and the self-heat temperature increase of each conductor within a valid heat-effective region of each segment. In some embodiments, the valid heat-effective region of each segment may include each segment and one or more extension regions thereof, the details of which can be referred to the embodiments of FIGS. 3A-3C. For example, an edge segment may include a one-side extension region, while a non-edge segment may include two-side extension regions. The calculation of the temperature increase of a specific segment may consider the temperature information of the conductors (e.g., polysilicon fingers) outside the specific segment, thereby providing a more precise temperature estimation result of the specific segment.

In operation 860, an evaluation (e.g., a second EM analysis) is conducted to the integrated circuit design layout using the calculated temperature increase of each segment. In some embodiments, the evaluation is an electromigration analysis. In some embodiments, operations 850 and 860 can be performed in a single EM analysis. Specifically, this EM analysis utilizes the calculated temperature increase of each segment to accurately determine the metal temperature resulting from metal thermal coupling.

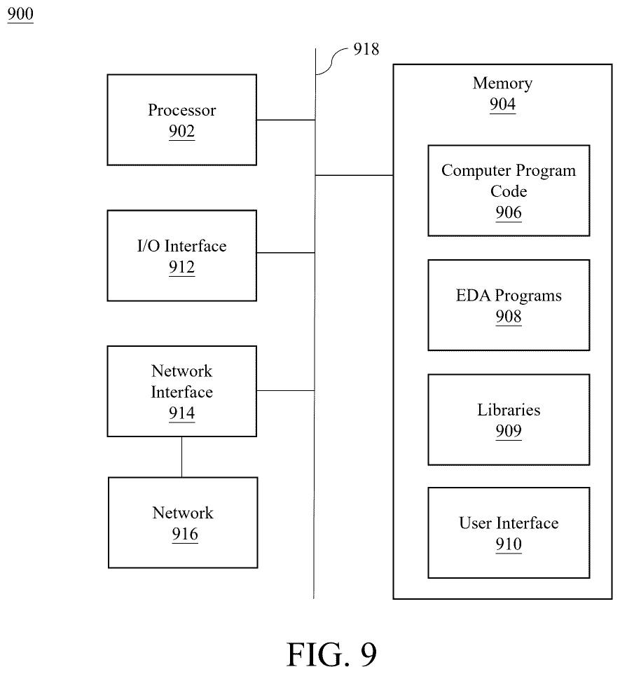

FIG. 9 is a block diagram of a computer device in accordance with some embodiments of the present disclosure.

In some embodiments, the computer device 900 may be a general purpose computing device configured to perform the EDA flow 700 shown in FIG. 7 and the flow 800 shown in FIG. 8. For example, the computer device 900 may include a processor 902, a memory 904, an input/output (I/O) interface 912, and a network interface 914 that are electrically coupled to each other via a bus 918. The network interface 914 may be connected to a network 916, so that the processor 902 and the memory 904 can be connected to external devices via the network 916.

In some embodiments, the processor 902 may be a central processing unit (CPU), a multi-processor, a distributed processing system, an application specific integrated circuit (ASIC), and/or a suitable processing unit. The memory 904 may be a non-transitory computer-readable storage medium that stores instructions or computer program codes 906. The processor 902 may be configured to execute the computer program code 906 and/or EDA programs 908 stored in the memory 904 to cause the computer device 900 to perform the EDA flow 700 shown in FIG. 7 and the flow 800 shown in FIG. 8.

In some embodiments, the memory 904 may be an electronic, magnetic, optical, electromagnetic, infrared, and/or a semiconductor system (or apparatus or device). For example, the memory 904 may include a semiconductor or solid-state memory, a magnetic tape, a removable computer diskette, a random access memory (RAM), a read-only memory (ROM), a rigid magnetic disk, and/or an optical disk. In one or more embodiments using optical disks, the memory 904 may include a compact disk-read only memory (CD-ROM), a compact disk-read/write (CD-R/W), and/or a digital video disc (DVD). In some embodiments, the memory 904 may also store information which facilitates performing a portion or all of the noted processes and/or methods. The EDA program 908 may include one or more LVS/DRC tools, parasitic extraction tools, post-layout simulation tools, and EM/IR analysis tools, etc., but the present disclosure is not limited thereto. In some embodiments, the memory 904 may further store one or more libraries, such as library 702, 706, and 708 shown in FIG. 7, that can be used during the EDA flow 700 performed by the processor 902.

In some embodiments, the I/O interface 912 may include a keyboard, keypad, mouse, trackball, trackpad, touchscreen, and/or cursor direction keys for communicating information and commands to the processor 902.

In some embodiments, the computer device 900 may be configured to receive information through the I/O interface 912. The information received through the I/O interface 912 may include one or more instructions, data, design rules, process performance histories, target ranges, set points, and/or other parameters for processing by the processor 902. The information may be transferred to the processor 902 through bus 918. In some embodiments, the computer device 900 may be configured to receive information associated with a user interface through the I/O interface 912. The information may be stored in the memory 904 as a user interface (UI) 910. In some embodiments, the memory 904 may further store one or more libraries 909, which include layout files of one or more integrated circuit design, STIL procedure files and test benches for the layout files, electromigration technology files, thermal side files, etc.

Therefore, the proposed methodology may offer a more precise temperature estimation result of each segment within the active region, along with a more reasonable evaluation of thermal-aware electromagnetic (EM) considerations for the layout of integrated circuit designs. Moreover, the proposed methodology effectively addresses the problem of invalid temperature estimation arising from the inclusion of new dummy polysilicon fingers. This ensures a balanced allocation of computing resources while maintaining the accuracy of electromagnetic estimation results.

An aspect of the present disclosure provides a method for evaluating temperature information of an integrated circuit. The method includes the following steps: identifying an active region in an integrated circuit design layout; dividing the active region into a plurality of segments, wherein each segment includes a plurality of conductors formed thereon; determining a weight of each conductor with respect to each segment; calculating a self-heat temperature increase of each conductor; and calculating a temperature increase of each segment using the weight and the self-heat temperature increase of each conductor within a valid heat-effective region of each segment.

Another aspect of the present disclosure provides a method for evaluating temperature information of an integrated circuit. The method includes the following steps: performing an parasitic extraction on an integrated circuit design layout to obtain a parasitic file associated with the integrated circuit design layout, which includes an active region and a plurality of polysilicon fingers formed thereon; performing a post-layout simulation on the integrated circuit design layout using a self-heating effect model and the parasitic file to obtain a self-heat temperature increase of each polysilicon finger within the integrated circuit design layout; and conducting an evaluation to the integrated circuit design layout using a first library and the self-heat temperature increase of each polysilicon finger within the integrated circuit design layout.

Yet another aspect of the present disclosure provides a computer device, which includes a memory and a processor. The memory is configured to store one or more electronic design automation (EDA) programs and a first library. The processor is configured to execute the one or more EDA programs to perform the following operations: performing an parasitic extraction on an integrated circuit design layout to obtain a parasitic file associated with the integrated circuit design layout, which includes an active region and a plurality of polysilicon fingers formed thereon; performing a post-layout simulation on the integrated circuit design layout using a self-heating effect model and the parasitic file to obtain a self-heat temperature increase of each polysilicon finger within the integrated circuit design layout; dividing the active region into a plurality of segments; and conducting a first electromigration analysis to each segment within the integrated circuit design layout using the first library and the self-heat temperature increase of each polysilicon finger within the integrated circuit design layout to obtain a temperature increase of each segment. The first library comprises an electromigration technology file and a thermal side file, the electromigration technology file is associated with the integrated circuit design layout, and the thermal side file records a heat distribution curve of each polysilicon finger.

The methods and features of the present disclosure have been sufficiently described in the provided examples and descriptions. It should be understood that any modifications or changes without departing from the spirit of the present disclosure are intended to be covered in the protection scope of the present disclosure.

Moreover, the scope of the present application is not intended to be limited to the particular embodiments of the process, machine, manufacture, and composition of matter, means, methods and steps described in the specification. As those skilled in the art will readily appreciate from the present disclosure, processes, machines, manufacture, composition of matter, means, methods or steps presently existing or later to be developed, that perform substantially the same function or achieve substantially the same result as the corresponding embodiments described herein, can be utilized according to the present disclosure.

Accordingly, the appended claims are intended to include within their scope processes, machines, manufacture, compositions of matter, means, methods or steps. In addition, each claim constitutes a separate embodiment, and the combination of various claims and embodiments are within the scope of the present disclosure.

What is claimed is:

1. A method for evaluating temperature information of an integrated circuit, comprising:
identifying an active region in an integrated circuit design layout; dividing the active region into a plurality of segments, wherein each segment comprises a plurality of conductors formed thereon;
determining a weight of each conductor with respect to each segment;
calculating a self-heat temperature increase of each conductor; and
calculating a temperature increase of each segment using the weight and the self-heat temperature increase of each conductor within a valid heat-effective region of each segment.

2. The method of claim 1, wherein the active region is an oxide diffusion region in which transistors and other functional semiconductor device elements of an integrated circuit design associated with the integrated circuit design layout.

3. The method of claim 1, wherein the plurality of conductors comprise polysilicon fingers.

4. The method of claim 3, wherein each segment has substantially a first width.

5. The method of claim 4, wherein the polysilicon fingers are evenly distributed to each segment on the active region.

6. The method of claim 1, wherein the valid heat-effective region of each segment comprises a respective segment and one or more extension regions thereof.

7. The method of claim 6, wherein an extension width of each extension region with respect to each segment is determined based on a heat distribution curve of each conductor with respect to each segment.

8. The method of claim 7, wherein the temperature increase of each segment caused by each conductor within the one or more extension regions of each segment is above a predetermined ratio of a maximum temperature within the heat distribution curve of each conductor.

9. The method of claim 1, wherein the plurality of segments comprise:
a first edge segment, located at a first side of the active region;
a second edge segment, located at a second side of the active region opposite to the first side; and
one or more non-edge segments located between the first edge segment and the second edge segment.

10. The method of claim 9, wherein each of the first edge segment and the second edge segment comprises a one-side extension region, and each of the one or more non-edge segments comprises two-side extension regions.

11. The method of claim 1, further comprising:
conducting an evaluation of the integrated circuit design layout using the calculated temperature increase of each segment.

12. The method of claim 11, wherein the evaluation is an electromigration analysis.

13. A method for evaluating temperature information of an integrated circuit, comprising:
performing an parasitic extraction on an integrated circuit design layout to obtain a parasitic file associated with the integrated circuit design layout, which includes an active region and a plurality of polysilicon fingers formed thereon;
performing a post-layout simulation on the integrated circuit design layout using a self-heating effect model and the parasitic file to obtain a self-heat temperature increase of each polysilicon finger within the integrated circuit design layout; and
conducting an evaluation to the integrated circuit design layout using a first library and the self-heat temperature increase of each polysilicon finger within the integrated circuit design layout.

14. The method of claim 13, wherein the evaluation is an electromigration analysis.

15. The method of claim 14, wherein conducting the evaluation to the integrated circuit design layout using the first library and the self-heat temperature increase of each polysilicon finger within the integrated circuit design layout comprises:
evenly dividing the active region into a plurality of segments;
determining a weight of each conductor with respect to each segment; and
calculating a temperature increase of each segment using the weight and the self-heat temperature increase of each polysilicon finger within a valid heat-effective region of each segment.

16. The method of claim 15, wherein the valid heat-effective region of each segment comprises a respective segment and one or more extension regions thereof.

17. The method of claim 16, wherein an extension width of each extension region with respect to each segment is determined based on a heat distribution curve of each conductor with respect to each segment.

18. The method of claim 17, wherein the first library comprises an electromigration technology file and a thermal side file, the electromigration technology file is associated with the integrated circuit design layout, and the thermal side file records the heat distribution curve of each polysilicon finger.

19. A computer device, comprising:
a memory, configured to store one or more electronic design automation (EDA) programs and a first library; and
a processor, configured to execute the one or more EDA programs to perform the following operations:
performing an parasitic extraction on an integrated circuit design layout to obtain a parasitic file associated with the integrated circuit design layout, which includes an active region and a plurality of polysilicon fingers formed thereon;
performing a post-layout simulation on the integrated circuit design layout using a self-heating effect model and the parasitic file to obtain a self-heat temperature increase of each polysilicon finger within the integrated circuit design layout;
dividing the active region into a plurality of segments; and
conducting a first electromigration analysis to each segment within the integrated circuit design layout using the first library and the self-heat temperature increase of each polysilicon finger within the integrated circuit design layout to obtain a temperature increase of each segment,
wherein the first library comprises an electromigration technology file and a thermal side file, the electromigration technology file is associated with the integrated circuit design layout, and the thermal side file records a heat distribution curve of each polysilicon finger.

20. The computer device of claim 19, wherein the processor is further configured to conduct a second electromigration analysis to the integrated circuit design layout using the calculated temperature increase of each segment.
